(19) United States
(12) Patent Application Publication
(10) Pub. No.: US 2016/0344949 A1
(43) Pub. Date: Nov. 24, 2016

(54) SYSTEM AND METHOD AND DEVICE FOR PROCESSING DIGITAL IMAGES

(71) Applicant: Leigh Mitchell Rothschild, MIAMI, FL (US)

(72) Inventor: Leigh Mitchell Rothschild, MIAMI, FL (US)

(73) Assignee: Ariel Inventions, LLC, MIAMI, FL (US)

(21) Appl. No.: 15/000,050

(22) Filed: Jan. 19, 2016

Related U.S. Application Data
(60) Provisional application No. 62/165,197, filed on May 22, 2015.

(51) Int. Cl. H04N 5/262; H04N 5/28

(52) U.S. Cl. CPC H04N 5/2628; H04N 5/28

(57) ABSTRACT

A system for processing digital images is configured to receive a plurality of digital images and receive at least one criterion, which is defined by a user. The system is further configured to identify one or more digital images, among the plurality of digital images, which are capable of meeting the criterion. The system is additionally configured to alter the identified one or more images to meet the criterion.

### CROSS REFERENCE TO RELATED APPLICATIONS

This application claims priority to U.S. Provisional Application 62/165,197 filed May 22, 2015, the content of which is incorporated by reference.

### BACKGROUND

Unless otherwise indicated herein, the materials described in this section are not prior art to the claims in this application and are not admitted to be prior art by inclusion in this section.

The subject matter in general relates to portable image capturing devices, more particularly, but not exclusively, the subject matter relates to capturing images without a user having to deliberately aim the portable image capturing device to compose a picture to be captured as an image that meets the user's criteria to retain the image.

Each year billions of digital images are captured by people around the world. Images are captured using a variety of portable image capturing devices such as cameras, sport cameras, tablets, and smart-phones. Typically a user aims the image capturing device, and might even zoom in/out, to frame a picture while viewing the picture in a viewfinder or a display of the device, and provides a command to capture the framed picture as a digital image. An advantage of the user deliberately framing a picture and then capturing the image is that, once the images are captured, lesser number of captured images may be discarded.

Although there is an advantage in the user deliberately framing the picture, there are several use cases wherein images have to be captured when the user is not in a situation to deliberately frame/compose the picture to be captured. As an example, a user would want “on-the-go images” to be captured while the user is biking. Companies such as GOPRO and SONY, among others, sell specialty image capturing devices that enable users to capture on-the-go images. Typically such devices are put in auto image capture mode routine in which the device captures a multitude of images. Even though the device captures a multitude of images, frame(s) a user would wish to be captured may not be captured in the multitude of images. Further, the user has to sort out the multiple images and manually select the images, among the multitude of captured images, to utilize and retain.

In light of the foregoing discussion, there is a need to enable users to capture images without the user deliberately framing the pictures to be captured and achieving images that the user is likely to utilize and/or retain.

### SUMMARY

According to an aspect of the present disclosure a system for processing digital images is provided. The system is configured to receive a plurality of digital images. The system is further configured to receive at least one criterion, which is defined by a user. The system is additionally configured to identify one or more digital images, among the plurality of digital images, that are capable of meeting the criterion. The system is also configured to alter the identified one or more images to meet the criterion.

According to another aspect of the present disclosure a portable digital image capturing device is provided. The digital image capturing device includes at least one image capture module configured to capture digital images. The digital image capturing device further includes a display terminal configured to display the digital images captured by the image capture module, wherein one or more digital images, which meet at least one criterion, are distinguished from remaining of the displayed digital images.

According to yet another aspect of the present disclosure a method for processing images is provided. The method includes receiving at least one criterion, which is defined by a user. The method further includes capturing a plurality of digital images, wherein one or more images among the plurality of digital images are captured based on the at least one criterion. The method additionally includes displaying the captured digital images, wherein one or more digital images, which meet the at least one criterion, are distinguished from remaining of the displayed digital images.

These and other features and advantages will become more clear when the drawings as well as the detailed description are taken into consideration.

### BRIEF DESCRIPTION OF THE DRAWINGS

Embodiments are illustrated by way of example and not limitation in the Figures of the accompanying drawings, in which like references indicate similar elements and in which:

FIG. 1A illustrates a portable digital image capturing device 100 mounted to a head gear of a cyclist;

FIG. 1B is a block diagram of a digital image capturing device 100, in accordance with an embodiment;

FIG. 2A is a flow chart of a method for capturing and processing digital images, in accordance with an embodiment;

FIG. 2B is a flow chart of a method for capturing and processing digital images, in accordance with another embodiment; and

FIGS. 3A-3E illustrate example user interface screens to enable capturing and processing of digital images.

### DETAILED DESCRIPTION

The following detailed description includes references to the accompanying drawings, which form part of the detailed description. The drawings show illustrations in accordance with example embodiments. These example embodiments are described in enough detail to enable those skilled in the art to practice the present subject matter. However, it will be apparent to one of ordinary skill in the art that the present invention may be practiced without these specific details. In other instances, well-known methods, procedures and components have not been described in detail so as not to unnecessarily obscure aspects of the embodiments. The embodiments can be combined, other embodiments can be utilized or structural and logical changes can be made without departing from the scope of the invention. The following detailed description is, therefore, not to be taken as a limiting sense.

In this document, the terms “a” or “an” are used, as is common in patent documents, to include one or more than one. In this document, the term “or” is used to refer to a nonexclusive “or,” such that “A or B” includes “A but not B,” “B but not A,” and “A and B,” unless otherwise indicated.

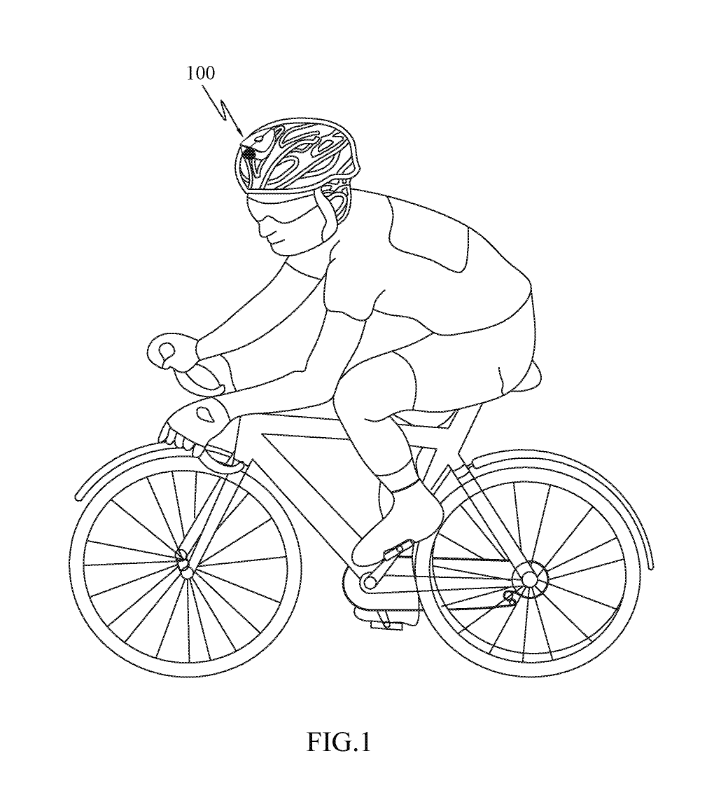

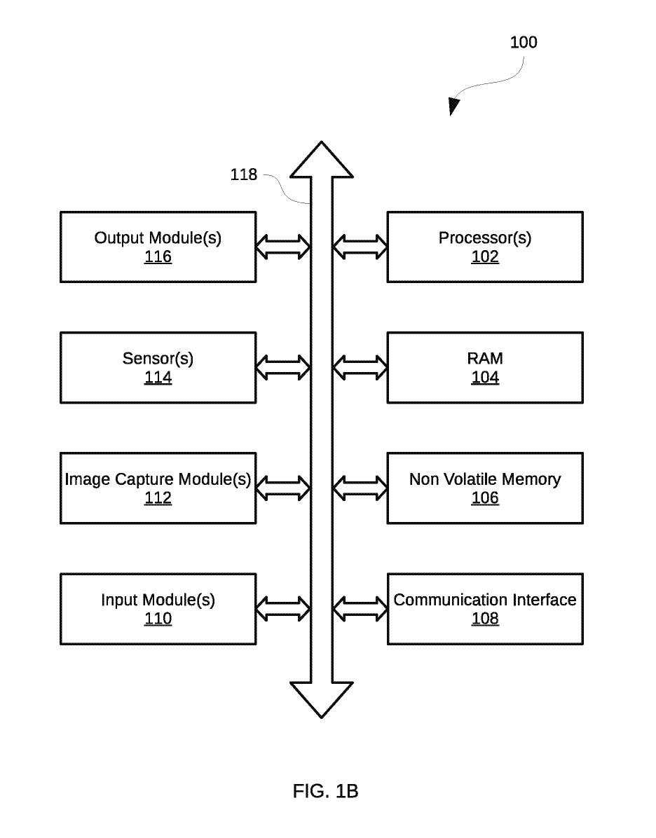

Referring to the figures, and more particularly to FIG. 1A and FIG. 1B, a portable digital image capturing device 100 is provided. Examples of the portable digital image capturing device 100 may include, but not limited to, a dedicated digital camera whose primary functionality is capturing digital images, smart-phone equipped with one or more cameras and tablet equipped with one or more cameras.

In an embodiment, the device 100 is configured to be coupled to one or more types of mounts. The mounts may enable the device 100 to be mounted to, as examples, user's body (ex: forearm), accessory (ex: helmet) used by a user, and a vehicle (ex: cycle and motorbike, among others), so that the user's hands are free to perform activities, which otherwise would be engaged in deliberately aiming the device 100 to compose a picture to be captured as a digital image.

The device 100 may include one or more processors 102, a random access memory 104, a disk drive or non-volatile memory 106, a communication interface 108, input module(s) 110, image capture module(s) 112, sensor(s) 114, output module(s) 116 and bus system 118. Further, some of the functionality of the device 100 may be distributed across one or more devices that may be located, remotely from or external to, the device 100.

The processor 102 may be any hardware which returns output by accepting signals, such as electrical signals as input. In one embodiment, processors 102 may include one or more computer processing units (CPUs). The processor(s) 102 may communicate with a number of peripheral devices via the bus system 118. The processor(s) 102 may be implemented as appropriate in hardware, computer-executable instructions, firmware, or combinations thereof. Computer-executable instruction or firmware implementations of the processor(s) 102 may include computer-executable or machine-executable instructions written in any suitable programming language to perform the various functions described.

Communications interface 108 may provide an interface to other communication networks and devices. Communication interface 108 may enable communication via wired, wireless or a combination or wired and wireless means.

The input module(s) 110 may include one or more possible types of devices and mechanisms for inputting information to the device 100. Image capture module(s) 112 may be a type of an input module that is include in the device 100. One or more image capture modules 112 may be included in the device 100. The image capture module 112 may capture images in digital form. The image capture module 112 may include an image sensor, an analog-to-digital (A/D) converter and a digital signal processor (DSP). As the image capture module 112 receives instructions from the processor 102 to capture an image, light is allowed to enter through the lens of the capture module 112 and shine on the image sensor, e.g., a charge-coupled device (CCD) or complimentary metal-oxide semiconductor (CMOS). The image sensor includes preferably millions of photosensors, e.g., pixels, wherein each pixel absorbs the light and transforms the light into an electric charge proportional to the intensity of light. Each charge is transmitted to an A/D converter where the charge is converted into a digital value representing the color the pixel will be, e.g., representing different intensities of red, green and blue. The digital values are then passed to the digital signal processor which may enhances the image, compresses it and then stores it in a digital file format in memory.

The memory may be volatile, such as random access memory 104 and/or a disk drive or non-volatile memory 106. The memory may store data and program instructions that are loadable and executable on the processor(s) 102, as well as data generated during the execution of these programs. The memory may be removable memory such as a CompactFlash card, Memory Stick, SmartMedia, MultiMediaCard (MMC), SD (Secure Digital) memory, or any other memory storage that exists currently or will exist in the future. The digital file format utilized to store the image is not critical, but may include standard file formats which currently exist or will exist in the future for example jpeg, tiff, bmp, gif, pcx, png or other file formats.

Sensor(s) 114 may be another type of input included in the device 100. Examples of one or more types of sensors included in the device 100 may include, but not limited to, accelerometer, altitude detector, gyroscope, Global Positioning System Module (GPS), light sensor and climate sensor(s). The climate sensor(s) may be capable of providing data corresponding to moisture, humidity, temperature and barometric pressure, among others. The Device 100 may also include a time and date module which is usually incorporated into the processor 102 to provide date and time information.

The output module 116 may be one or more possible types of devices and mechanisms for outputting information from the device 100. A display terminal may be an output module included in the device 100. The display terminal is provided for displaying the captured digital images. A speaker or speakers may be provided on the device 100 for outputting audio signals to the user. Additionally, a microphone may be provided on the device 100 for inputting audio signals to the device. This microphone may also be used for voice recognition to convey commands from the user to the device 100. The display terminal may also be used for providing input. The display terminal may include a touch screen for facilitating user to input information. The display terminal may be in any current form in the art, including Liquid Crystal Displays (LCD), Light emitting diode displays (LED), Cathode Ray Tube Displays (CRT) or any other type of display currently existing or existing in the future.

An embodiment of the device 100 enables a user to input one or more criterion for capturing digital images. The device 100 captures multitude of digital images. Some of the images among the multitude of digital images may be captured based on trigger generated as a consequence of the criterion. The captured digital images are displayed on a display terminal of the device 100. Among the displayed digital images, those digital images that meet the user defined criterion are distinguished from those that do not meet the user defined criterion.

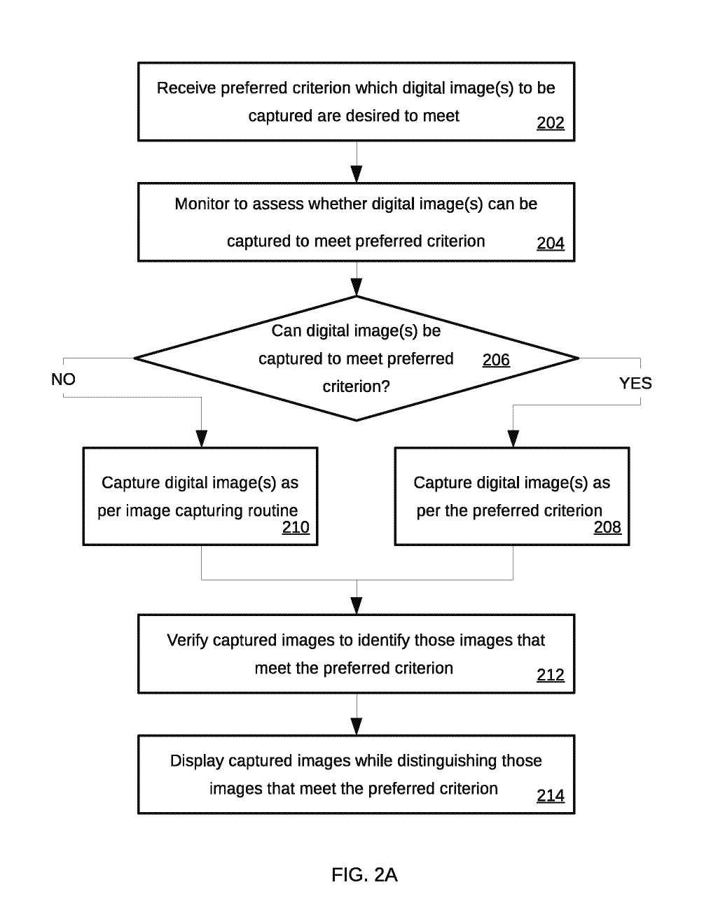

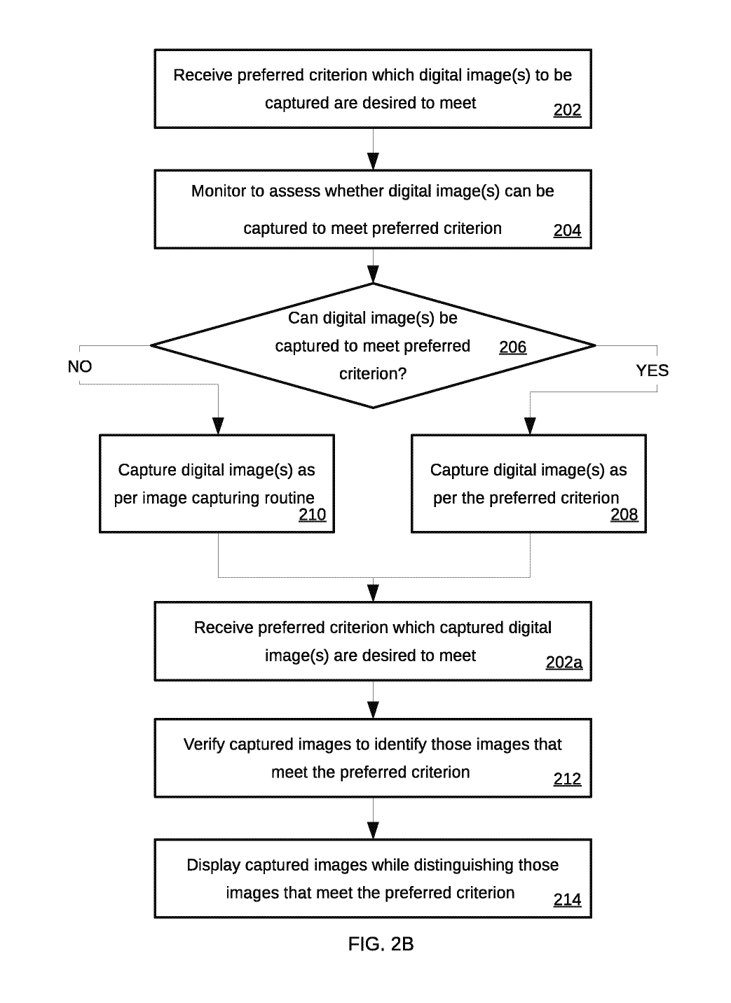

Referring more particularly to FIG. 2A, a method for capturing and processing digital images is provided. At step 202, one or more preferred criterion, which one or more digital images to be captured are desired to meet, are received. At step 204, monitoring is carried out to assess whether one or more digital images can be captured to meet the predefined preferred criterion. In case, at step 206, assessment is made that one or more digital images can be captured to meet the predefined preferred criterion, then at step 208, one or more digital images are captured as per the criterion. On the other hand, at step 206 if assessment is made that one or more digital images cannot be captured to meet the predefined preferred criterion, then at step 210, one or more digital images are captured as per image capturing routine defined in the device 100. At step 212, the captured digital images are verified to identify those digital images that meet the predefined preferred criterion. At 214, plurality of captured digital images are displayed, and among those, the digital images that meet the predefined preferred criterion are distinguished from those that do not meet the predefined criterion.

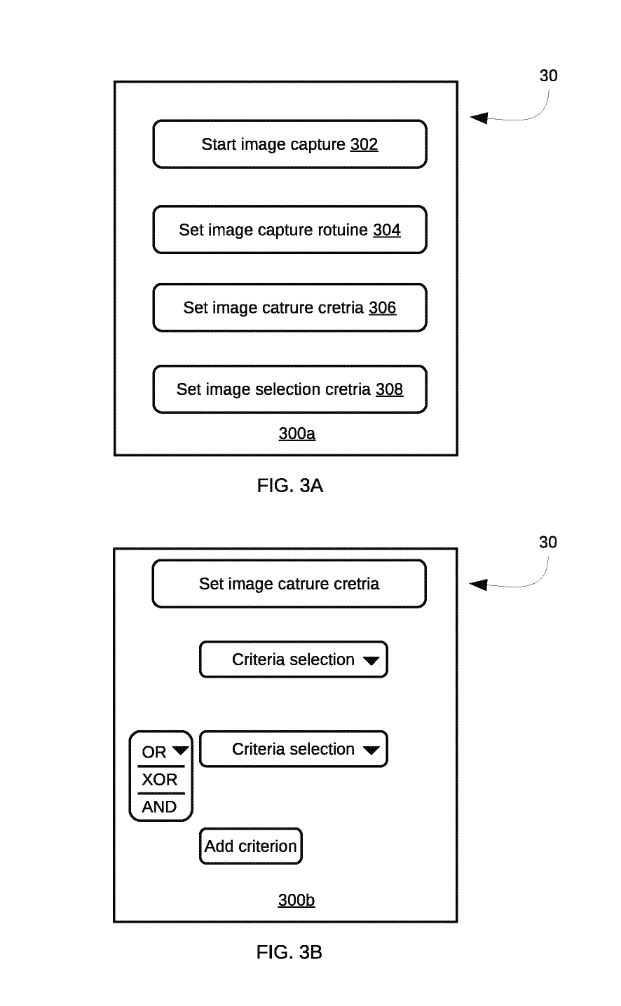

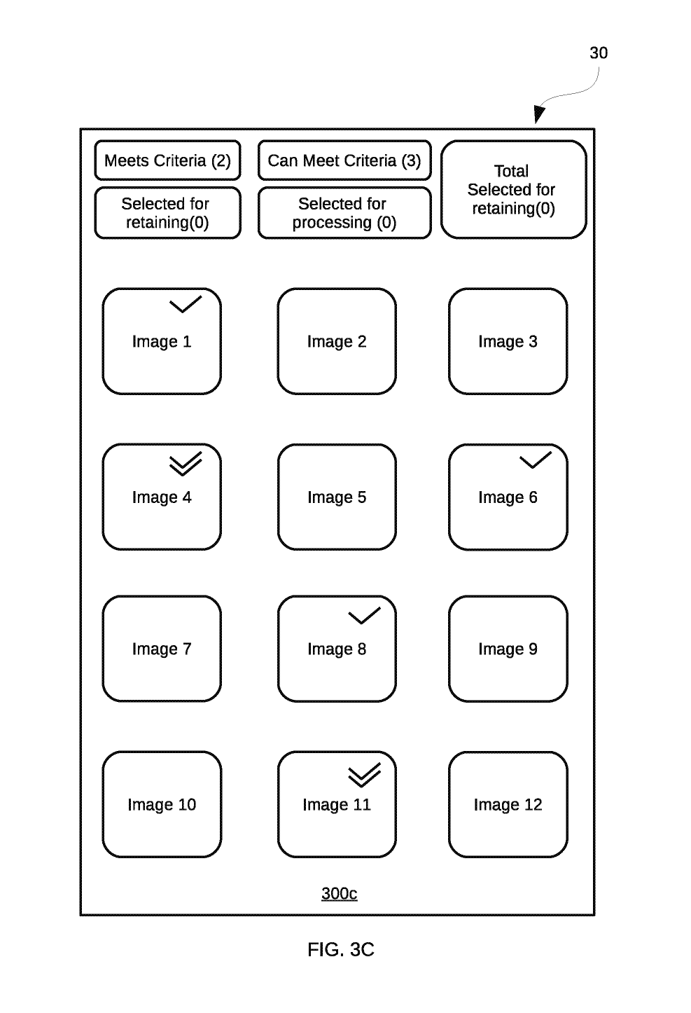

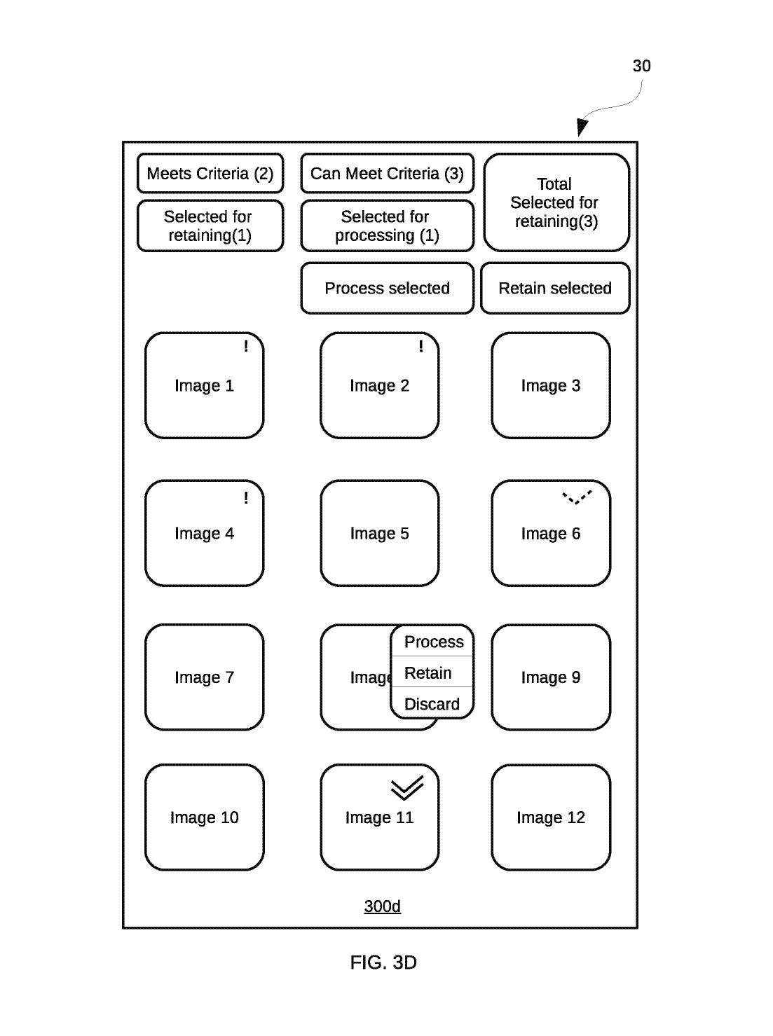

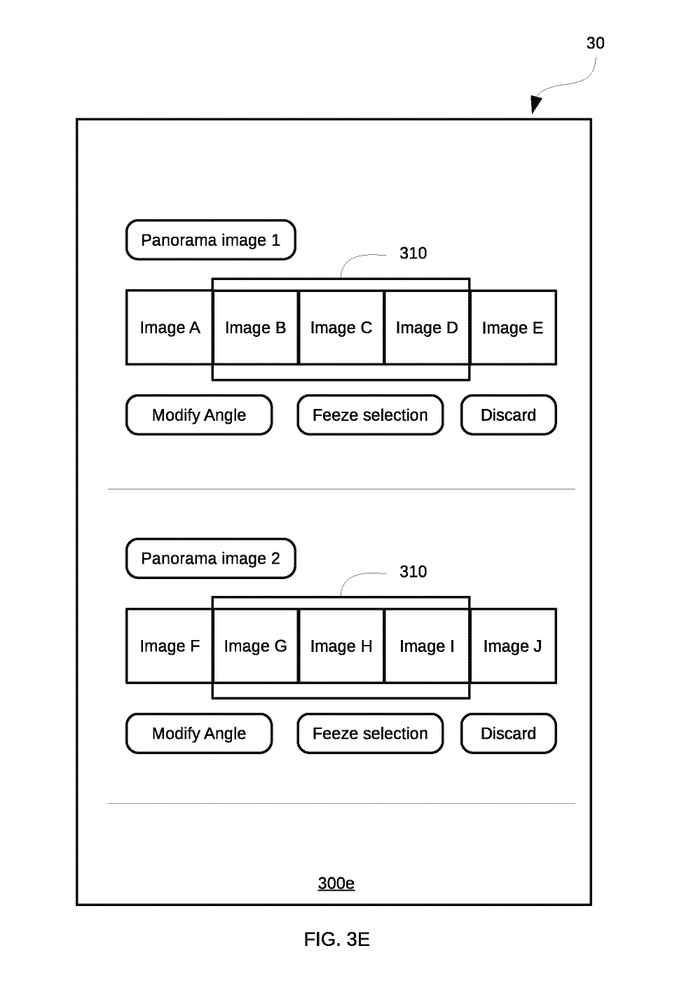

Referring to the step (step 202) of receiving one or more preferred criterion, which one or more digital images to be captured are desired to meet, a user may specify the preferred criterion which may be received by the device 100. The user may define the criterion via a touch screen display terminal of the device 100. Referring to FIG. 3A, a “set image capture criteria” button 306 displayed in user interface screen 300a of a display terminal 30 of the device 100 may be activated, by touching as an example, to define one or more preferred criterion, which one or more digital images to be captured are desired to meet.

In an embodiment, a plurality of criteria may be defined. Referring particularly to FIG. 3B, activation of the “set image capture criteria” button 306 (illustrated in FIG. 3A) may result in displaying of a user interface screen 300b using which one or more criterion may be defined. Further, in case the user wishes to define more than one criterion, then the relationship between criteria may also be defined by the user. The relationship may be, as examples, in the form of exclusive OR (XOR), inclusive OR (OR) and AND. XOR, OR and AND may be referred to as relationship operators. The relationship operator between two criteria may be selected, as an example, by means of a drop-down that provides the options of relationship operators. Further, two or more criteria may be grouped to define how operators have to be applied. As an example, if C1, C2 and C3 are three criteria, then a first example of grouping, such as (C1 OR C2) AND C3 would define a logic that is different from a second example of grouping, such as C1 OR (C2 AND C3). One of the example techniques of grouping criteria may be achieved by enabling the user to define sets of criteria, wherein criterion/criteria in a set belong to a group, and operators may be defined between sets.

In an embodiment, at least two criterion among the plurality of criteria may have an inclusive OR relationship.

In an embodiment, at least two criterion among the plurality of criteria may have an exclusive OR relationship.

In an embodiment, at least two criterion among the plurality of criteria may have an AND relationship.

In an embodiment, a criterion that may be defined by a user may be a line of sight at which a desired digital image is captured. Line of sight of an image capture module 116 may mean the line of sight of the image capture module 116 with respect to a horizontal place. The line of sight may be defined by means of angle at which the line of sight is incident to the horizontal plane. The angle(s) may be defined using one or a combination of =, > and <. It may be noted that range of angles may be defined.

In an embodiment, a criterion that may be defined by a user may be presence of one or more predefined entity in a desired digital image. The entity may be a living or a non-living entity. Further, the entity may be a human or a non-human living entity. The entity or entities may be selected from a pre-defined list of entities present in the device 100. Examples of pre-defined list of entities may include, but not limited to, human face, dog, human body, bicycle, sun, moon and trees. Alternatively or additionally, real digital photographs of entities may be fed to the device 100 by a user either through digital capture of images by the device, or input through a remote server utilizing the devices communication module. Upon feeding a photograph, the device 100 may recognize one or more entities/objects (ex. plurality of human faces) in the photograph. The user may select one or more of the recognized entity/entities as entity/entities to be used as criterion. The device 100 may process the picture being composed to determine whether the one or more entities are present in the picture, and trigger image capturing if present.

In an embodiment, a criterion that may be defined by a user may be absence of one or more predefined entity in a desired digital image. The entity may be a living or a non-living entity. Further, the entity may be a human or a non-human living entity. The entity or entities may be selected from a pre-defined list of entities present in the device 100. Examples of pre-defined list of entities may include, but not limited to, human face, dog, human body, bicycle, sun, moon and trees. Alternatively or additionally, real digital photographs of entities may be fed to the device 100 by a user either through digital capture of images by the device, or input through a remote server utilizing the devices communication module. Upon feeding a photograph, the device 100 may recognize one or more entities/objects (ex. plurality of human faces) in the photograph. The user may select one or more of the recognized entity/entities as entity/entities to be used as criterion.

In an embodiment, a criterion that may be defined by a user may be color properties of a desired digital image. The color properties of a desired image may be, as example, whether the desired image has to be in monotone or color.

In an embodiment, a criterion that may be defined by a user may be orientation of a desired digital image. The orientation of the desired digital image may be, as example, landscape or portrait.

In an embodiment, a criterion that may be defined by a user may be angle of view of a desired digital image. The angle of view or field of view may be defined to indicate that compositing of plurality of images are desired to achieve the desired angle of view. The user may set a criterion that panoramic imaging is desired, and may further define the angle of the panoramic imaging. The device may use input received from its sensor(s) 114, such as the accelerometer and gyroscope, to trigger capturing of plurality of digital images that can be composited to achieve the desired angle of view or panoramic image(s) obtained by compositing digital images.

In an embodiment, a criterion that may be defined by a user may be location at which a desired digital image is shot. The location may be determined using information received by the GPS module provided in the device 100.

In an embodiment, a criterion that may be defined by a user may be time at which a desired digital image is shot. The user may also specify date. The time and date module incorporated into the processor 102 may be used to trigger image capturing.

In an embodiment, a criterion that may be defined by a user may be altitude at which a desired digital image is shot. The altitude may be determined using information received by altitude detector provided in the device 100.

In an embodiment, a criterion that may be defined by a user may be speed at which a desired digital image is shot. The speed in the current context may refer to the speed at which the device 100 is traveling, which may be determined using information received from one or more sensors 114 of the device 100.

In an embodiment, a criterion that may be defined by a user may be climate condition at which a desired digital image is shot, which may be determined using information received from one or more sensors 114 of the device 100.

In an embodiment, a criterion that may be defined by a user may be usage of flash light while shooting a desired digital image.

In an embodiment, a criterion that may be defined by a user may be zoom level at which a desired digital image is shot. The zoom level may be associated with entity criterion so that zoom level when an entity is identified is adjusted as per the criteria.

Referring to the step of (step 204) monitoring to assess whether one or more digital images can be captured to meet the predefined preferred criterion, the device 100 may carry out the monitoring. In an embodiment, monitoring may be carried by processing pictures being framed in the device 100. For example, monitoring the pictures being framed in the device 100 may enable determination of presence or absence of one or more entities in the framed pictures. Further, monitoring may be carried using information received by one or more sensors 114 of the device 100. Additionally, monitoring may be carried out using information received by the time and date module of the device 100.

In an embodiment, a user may define the number of digital images to be captured. The number may be defined as a range. Alternatively, a whole number may be defined by the user. The number of images to be captured may be limited by a time period. As an example, the user may specify that 100 images should be captured in the next 120 minutes. In case, the number is defined, the device captures images to meet the instant criteria.

Referring to the step (step 208) of capturing one or more digital images as per the criterion/criteria, in case assessment is made (step 206) based on monitoring that one or more digital images can be captured to meet the predefined preferred criterion/criteria, then one or more digital images are captured as per the criterion/criteria. The processor 102 may send instructions to one or more image capture modules 112 to capture digital image(s), when the processor 102 determines that image(s) can be captured to meet the predefined preferred criterion/criteria. The one or more image capture modules 112 captures image(s) based on the instructions received by the processor 112.

Referring to the step (step 210) of capturing one or more digital images as per image capturing routine, in case assessment is made (step 206) based on monitoring that one or more digital images cannot be captured to meet the predefined preferred criterion/criteria, even then one or more digital images may be captured based on image capturing routine defined in the device 100. The routine may be a preset periodic image capturing routine. As an example, a image may be captured once in every thirty second.

Referring to the step (step 212) of verifying the captured digital images to identify those digital images that meet the predefined preferred criterion/criteria, the verification may be carried out by the processor 112 of the device 100. Alternatively, verification may be carried out by a computing device other than the device 100. The computing device other than the device 100 may be as examples, a remote server or a user computing device. As an example, the captured digital images may be transferred to the computing device along with the criterion/criteria or additional criterion/criteria may be defined as input to the computing device, which carries out the verification.

Referring to the step (step 214) of displaying plurality of captured digital images, and among those, distinguishing the digital images that meet the predefined preferred criterion/criteria from those that do not meet the predefined criterion/criteria, the distinguishing may be in the form of visual distinguishing. Referring to FIG. 3C a user interface screen 300c may display a plurality of captured digital images, image 1, 2, 3 . . . Among the displayed digital images, those digital images that meet the user defined criterion/criteria may be identified (ex: image 4 and image 11). The identified digital images that meet the user defined criterion/criteria may be distinguished from those that do not meet the user defined criterion/criteria. As an example, a double tick mark may be an indication that the image meets the user defined criterion/criteria. Further, among the displayed digital images, those digital images that are capable of meeting the user defined criterion/criteria, subject to alteration/modification/processing/compositing may be identified (ex: images 1, 6 and 8). The identified digital images that are capable of meeting the user defined criterion/criteria may be distinguished from those that already meet or not capable of meeting the user defined criterion/criteria. As an example, a single tick mark may be an indication that the image is capable of meeting the user defined criterion/criteria. Although, as an example, tick marks are used for distinguishing, other forms of distinguishing are possible, such as color coding, framing and distinguishing using tabs, among others. Distinguishing may be carried out (in part or full) by the processor 112 of the device 100. Alternatively, distinguishing may be carried out (in part or full) by a computing device other than the device 100. As an example, the captured digital images may be transferred to the computing device along with the criterion/criteria or additional criterion/criteria may be defined as input to the computing device, which carries out the distinguishing steps.

Referring to FIG. 3D, as illustrated in user interface screen 300d as an example, one or more of the displayed images may be selected by the user for retaining. The selection may be of digital images that were distinguished as meeting the user defined criterion/criteria (ex: image 4 and image 11), digital images that were distinguished as capable of meeting the user defined criterion/criteria (ex: images 1, 6 and 8) or digital images that were distinguished as not capable of meeting the user defined criterion/criteria (ex: images 2, 3, 5, 7, 9, 10 and 12). The digital images that are selected for retaining may be distinguished from those images that are not yet selected for retaining. The distinguishing may be in the form of an exclamatory mark as an example. In the current example, images 1, 2 and 4 are selected for retaining. Further, a user is enabled to select one or more images that are distinguished as capable of meeting the user defined criterion/criteria (ex: images 1, 6 and 8) for altering (can mean processing, modifying or compositing, as examples), retaining or discarding. In the current example, image 1 is selected for retaining, image 6 is selected for altering and image 8 is undergoing the process of selection. The image (image 6 in this example) selected for altering may be distinguished with a dotted tick to indicate that the image is selected for altering. The displaying, selection or altering may be carried out (in part or full) by the processor 112 of the device 100. Alternatively, displaying, selection or altering may be carried out (in part or full) by a computing device other than the device 100.

In an embodiment, provision may be provided to mass select images that are identified as meeting the criterion/criteria, mass select images that are identified as capable of meeting the criterion/criteria or mass select images that are identified as not capable of meeting the criterion/criteria. The mass selected images that are identified as meeting the criterion/criteria may be marked for retaining, discarding or un-selecting some of the images that are selected. Likewise, mass selected images that are identified as capable of meeting the criterion/criteria may be marked for altering, retaining, discarding or un-selecting some of the images that are selected. Similarly, mass selected images that are identified as not capable of meeting the criterion/criteria may be marked for retaining, discarding or un-selecting some of the images that are selected.

In an embodiment, retaining can mean and include transferring the digital images to a destination, remote from or external to, the device 100 for storage.

In an embodiment, retaining can mean and include retaining storage of the digital images in the memory of the device 100. The retained digital images may then be transferred to a computing device external to the device 100.

In an embodiment, the captured digital images that are identified as being capable of meeting the user defined criterion/criteria are altered, without the user selecting the images for altering as discussed earlier, to meet the user defined criterion/criteria. In an embodiment, such altered images may be distinguished to indicate that they have been altered. The user may select/un-select such images for retaining.

In an embodiment, alteration includes, but not limited to, cropping a digital image, zooming into at least one defined entity, zooming out of at least one defined entity, altering focus, modifying color properties, changing orientation, changing aspect ration, achieving desired angle of view, compositing images, changing brightness, changing contrast and changing lighting properties.

Referring specifically to FIG. 3E, in an embodiment, the device 100 or a computing device external to the device 100 may enable a user to define an angle of view of one or more desired image. The user may specify that one or more desired images shall be a panoramic image, and may further define angle (or range of angle) of panorama. The device may composite digital images from the identified digital images to create at least one image that meet the criterion/criteria. The identified digital images A, B, C . . . may be displayed to a user. Additionally, the images may be grouped (grouping under panorama image 1 and panorama image 2, as examples) to indicate the image that can be formed using each of the grouped images. Further, the user may select digital images among the identified digital images for compositing. As an example, the window 310 may be moved to select the images (a portion of images may be selected towards one or more of each end, in an example) to be composited. The breadth/angle of view of the image may be changed using a push/pull interface that may be provided for the window 310 or by activating the “modify angle” button and defining angle of view. Once the user is satisfied with the selected images for compositing, the user may activate the “freeze selection” button, that may result in a final image that may be retained. The selected images may be composited to form a panoramic image of desired angle or an image with desired angle of view. The grouped images may also be discarded by activating the “discard” button.

In an embodiment, the panoramic image 1, 2 that is displayed may be composited prior to displaying to the user, and the display may enable changing the angle of view, for example, by cropping.

In an embodiment, digital images identified for retaining may be associated with symbology or identification code. Symbology or identification code may be in the form of a code, such as a bar code, that is machine readable, such as the one capable of being read by a scanner. The symbology or identification code may be in the form of a combination of alphanumeric characters. The symbology or identification code may be unique to each of the digital images. The symbology or identification code may be generated using information associated with the digital image. The information associated with the digital image may be information obtained by sensor(s) 114 of the device 100 or time and date module of the device 100. Alternatively, a machine readable code may be scanned, by device 100 as example, and associated with a digital image as symbology or identification code for that image. Information associated with the symbology or identification code along with the digital image may be stored in memory. The memory may be the memory of the device 100 or computing device external to the device 100. The digital image may be retrieved from where it is stored by providing symbology or identification code (or information associated with symbology or identification code).

Referring more particularly to FIG. 2B, a method for capturing and processing digital images is provided. The method may be similar to the method described in reference to FIG. 2A, however in the current embodiment, referring to step 202a, one or more preferred criterion may be defined after the digital images are captured. The criterion/criteria may be defined, as an example, by activating the “set image selection criteria” button 308. Criteria may be defined in a manner as discussed earlier. Further, it may be noted that some of the images that are captured as per image capture routine (step 210) may still satisfy the criterion/criteria that may be defined in step 202a. Further, images that may be captured as a result of a user specifically providing command, via remote, voice command or gesture, to capture images, may satisfy the criterion/criteria that may be defined in step 202a.

In an embodiment, the image capture routine may be defined by activating the “set image capture routine” button 304.

In an embodiment, a user may activate the “start image capture” button 302 to enable the device 100 to capture digital images based on the routine and the criterion/criteria that may be defined in step 202.

In an embodiment, the device may store information received from the sensor(s) 114 or time and date module, corresponding to the captured digital images, even though such storage is not necessitated by the criterion/criteria defined in step 202. Storage of such information may enable defining of broad range of criteria at step 202a for selection of digital images post capturing of the digital images.

In an embodiment, criterion/criteria may be defined only after the digital images are captured.

The processes described above is described as sequence of steps, this was done solely for the sake of illustration. Accordingly, it is contemplated that some steps may be added, some steps may be omitted, the order of the steps may be re-arranged, or some steps may be performed simultaneously.

The example embodiments described herein may be implemented in an operating environment comprising software installed on a processing system, in hardware, or in a combination of software and hardware.

Although embodiments have been described with reference to specific example embodiments, it will be evident that various modifications and changes may be made to these embodiments without departing from the scope of the claims. Accordingly, the specification and drawings are to be regarded in an illustrative rather than a restrictive sense.

Many alterations and modifications of the present invention will no doubt become apparent to a person of ordinary skill in the art after having read the foregoing description. It is to be understood that the phraseology or terminology employed herein is for the purpose of description and not of limitation. It is to be understood that the description above contains many specifications, these should not be construed as limiting the scope of the invention but as merely providing illustrations of some of the personally preferred embodiments of this invention.

What is claimed is:

1. A system for processing digital images, the system configured to:
receive a plurality of digital images;
receive at least one criterion, which is defined by a user;
identify one or more digital images, among the plurality of digital images, that are capable of meeting the criterion; and
alter the identified one or more images to meet the criterion.

2. The system of claim 1, wherein the plurality of digital images are captured by a portable digital image capturing device.

3. The system of claim 1, wherein the criterion is defined before at least the identified one or more digital images are captured.

4. The system of claim 1, wherein the criterion is defined after at least the identified one or more digital images are captured.

5. The system of claim 1, wherein the criterion is an angle of view of a desired image, wherein the system is configured to composite digital images from the identified digital images to create at least one image that meet the criterion.

6. The system of claim 5, wherein the system is configured to:
enable display on a display terminal the identified digital images; and
receive input selecting digital images among the identified digital images for compositing.

7. The system of claim 1, wherein the criterion corresponds to one or more of:
line of sight at which a desired digital image is captured;
presence of one or more predefined entity in a desired digital image;
absence of one or more predefined entity in a desired digital image;
color properties of a desired digital image;
orientation of a desired digital image;
angle of view of a desired digital image;
compositing to generate a desired digital image;
location at which a desired digital image is shot;
time at which a desired digital image is shot;
altitude at which a desired digital image is shot;
speed at which a desired digital image is shot;
climate condition at which a desired digital image is shot;
usage of flash light while shooting a desired digital image; and
zoom level at which a desired digital image is shot.

8. The system of claim 1, wherein the system is further configured to enable display of a plurality of the received digital images and distinguish the identified one or more digital images among the displayed digital images.

9. The system of claim 1, wherein the system is further configured to:
identify one or more digital images, among the plurality of digital images, that meet the criterion;
enable display of a plurality of the received digital images; and
distinguish the identified one or more digital images, which meet the criterion, among the displayed digital images.

10. The system of claim 9, wherein the system is further configured to:
distinguish the altered one or more digital images, among the displayed digital images;
receive a selection of one or more of the displayed digital images; and
enable retrieval of the selected one ore more digital images using symbology information associated with the selected one or more digital images.

11. A portable digital image capturing device comprising:
at least one image capture module configured to capture digital images; and
a display terminal configured to display the digital images captured by the image capture module, wherein one or more digital images, which meet at least one criterion, are distinguished from remaining of the displayed digital images.

12. The portable digital image capturing device of claim 11, wherein the display terminal is further configured to display the digital images captured by the image capture module, wherein one or more digital images, which are capable of meeting at least one criterion but haven't met the criterion yet, are distinguished from remaining of the displayed digital images.

13. The portable digital image capturing device of claim 11, wherein the display terminal is further configured to display the digital images captured by the image capture module, wherein one or more digital images, which are altered to meet at least one criterion, are distinguished from remaining of the displayed digital images.

14. The portable digital image capturing device of claim 11, configured to:
receive a selection of one or more digital images among the displayed digital image;
assign unique identification code to each of the selected digital images; and
transfer the selected digital images along with information associated with the identification code to a remote destination.

15. The portable digital image capturing device of claim 11, configured to receive one or more criterion as an input, wherein the criterion corresponds to one or more of:
line of sight at which a desired digital image is captured;
presence of one or more predefined entity in a desired digital image;
absence of one or more predefined entity in a desired digital image;
color properties of a desired digital image;
orientation of a desired digital image;
angle of view of a desired digital image;
compositing to generate a desired digital image;
location at which a desired digital image is shot;
time at which a desired digital image is shot;
altitude at which a desired digital image is shot;
speed at which a desired digital image is shot;
climate condition at which a desired digital image is shot;
usage of flash light while shooting a desired digital image; and
zoom level at which a desired digital image is shot.

16. The portable digital image capturing device of claim 11, is configured to receive the at least one criterion before the one or more digital images that meet the at least one criterion is captured by the portable digital image capturing device.

17. The portable digital image capturing device of claim 16, is configured to capture one or more digital images based on the at least one criterion.

18. The portable digital image capturing device of claim 11 is configured to receive a plurality of criteria, wherein at least two criterion among the plurality of criteria have an exclusive OR relationship.

19. The portable digital image capturing device of claim 11 is configured to receive a plurality of criteria, wherein at least two criterion among the plurality of criteria have an inclusive OR relationship.

20. The portable digital image capturing device of claim 11 is configured to receive a plurality of criteria, wherein at least two criterion among the plurality of criteria have an AND relationship.

21. A method for processing images, the method comprising:
receiving at least one criterion, which is defined by a user;
capturing a plurality of digital images, wherein one or more images among the plurality of digital images are captured based on the at least one criterion; and
displaying the captured digital images, wherein one or more digital images, which meet the at least one criterion, are distinguished from remaining of the displayed digital images.
